(19) United States
(12) Patent Application Publication
(10) Pub. No.: US 2018/0278564 A1
(43) Pub. Date: Sep. 27, 2018

(54) System and Method for Indirect Messaging

(71) Applicant: GooRoo Messaging Corporation, Montreal (CA)

(72) Inventor: Salomão TEIXEIRA DE SOUZA FILHO, Belo Horizonte (BR)

(21) Appl. No.: 15/996,025

(22) Filed: Jun. 1, 2018

Related U.S. Application Data
(63) Continuation of application No. PCT/CA2016/051383, filed on Nov. 24, 2016.
(60) Provisional application No. 62/262,608, filed on Dec. 3, 2015.

(51) Int. Cl. H04L 12/58

(52) U.S. Cl. CPC H04L 51/18; H04L 51/36; H04L 51/12; H04L 51/14

(57) ABSTRACT

A system and method are provided for sending a message from a sender to a recipient. The method comprises enabling the recipient to be identified for the message; enabling an intermediary to be identified for the message; and sending the message to the intermediary to have the intermediary send the message to the recipient on behalf of the sender without divulging an identity associated with the sender to the recipient.

### CROSS-REFERENCE TO RELATED APPLICATION(S)

This application is a continuation of PCT Application No. PCA/CA2016/051383 filed on Nov. 24, 2016, which claims priority to U.S. Provisional Patent Application No. 62/262,608 filed on Dec. 3, 2015, both incorporated herein by reference.

### TECHNICAL FIELD

The following relates to systems and methods for indirect messaging.

### DESCRIPTION OF THE RELATED ART

It is becoming more and more common for individuals to communicate with each other using communication devices such as smartphones, laptops, tablets, PCs, gaming devices, infotainment systems, etc.; with various social and messaging media. In most if not all media, the user either uses established “contacts” or “buddies” with which to communicate, or otherwise has an address that allows them to contact the other party. For established contacts and in communication media requiring address entry, the sender is typically either known to the recipient or revealed when the message is received. While there are ways to conceal your identity as a sender, e.g., by creating impersonal usernames or avatars, the anonymity can lead either to messages being ignored and/or be burdensome to use.

### SUMMARY

In one aspect, there is provided a method of sending a message from a sender to a recipient, the method comprising: enabling the recipient to be identified for the message; enabling an intermediary to be identified for the message; and sending the message to the intermediary to have the intermediary send the message to the recipient on behalf of the sender without divulging an identity associated with the sender to the recipient.

In at least some implementations, the message is removed from the intermediary's device after a predetermined amount of time. In other implementations, the system is configured to enable the sender to set one or more privacy settings. In yet another implementation, the system is further configured for receiving a reply from the recipient via the intermediary.

In other aspects, there are provided a computer readable medium and electronic device configured to perform the above method.

### BRIEF DESCRIPTION OF THE DRAWINGS

Embodiments will now be described by way of example only with reference to the appended drawings wherein:

FIG. 1 is a schematic block diagram of an example of an indirect messaging system;

FIG. 2 is a schematic block diagram of an example of an indirect messaging system utilizing an indirect messaging service;

FIG. 3 is a schematic block diagram of an example of an indirect messaging system utilizing an indirect messaging service and at least one other service for acquiring new users;

FIG. 4 is a block diagram of an example of a configuration for a user device that can be used by a sender, an intermediary, and a recipient;

FIG. 5 is a block diagram of an example of a configuration for an indirect messaging service;

FIG. 6 illustrates contact list concordance for indirect messaging via an intermediary;

FIG. 7A is a flow chart illustrating computer executable operations for preparing and sending message to a recipient via a selected intermediary;

FIG. 7B is a flow chart illustrating computer executable operations for determining suitable intermediary candidates;

FIG. 8 is a flow chart illustrating computer executable operations for processing a received message at the intermediary;

FIG. 9 is a flow chart illustrating computer executable operations for processing a received message at the recipient;

FIG. 10 is a flow chart illustrating computer executable operations for acquiring a new user via another messaging service; and

FIG. 11 is a flow chart illustrating computer executable operations for using an intermediary and the indirect messaging system to request an introduction to a recipient.

### DETAILED DESCRIPTION

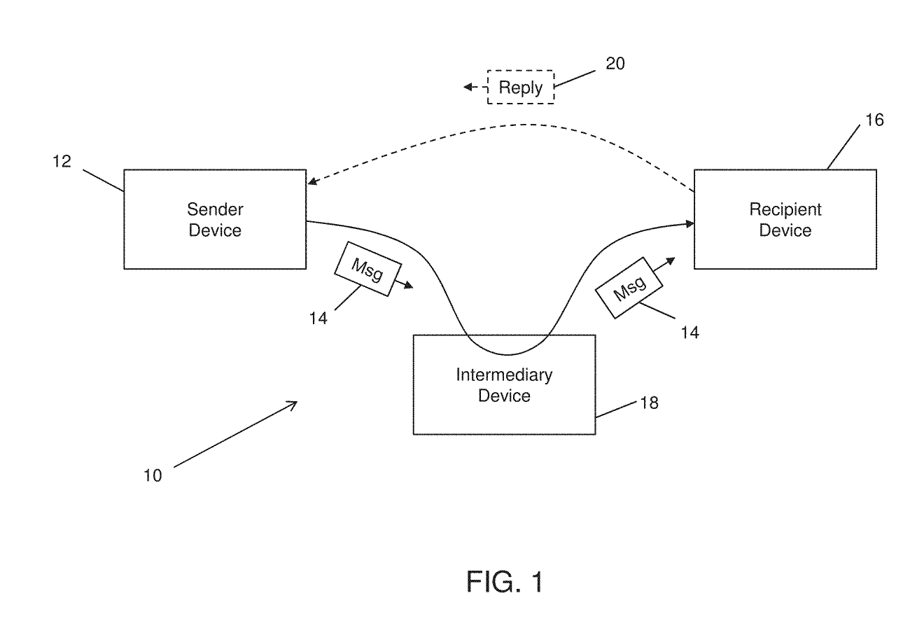

FIG. 1 illustrates an indirect messaging system 10 in which a sender device 12 is able to send a message 14 to a recipient device 16 via an intermediary device 18. The message 14 can be unidirectional, or can optionally trigger a subsequent message exchange between the recipient device 16 and the sender device 12, e.g., by way of a reply 20 generated and sent by the recipient device 16. The reply 20 shown in FIG. 1 can remain anonymous in that the recipient is unaware of the identity of the sender until which time the sender divulges this information (e.g., in a further message 14). It can be appreciated that the devices 12, 16, 18 can be associated with a user, entity, organization, virtual bot, etc. However, for the purposes of illustration, the following examples may be given in the context of users having personal devices 12, 16, 18, but this is not meant to be limiting in any way.

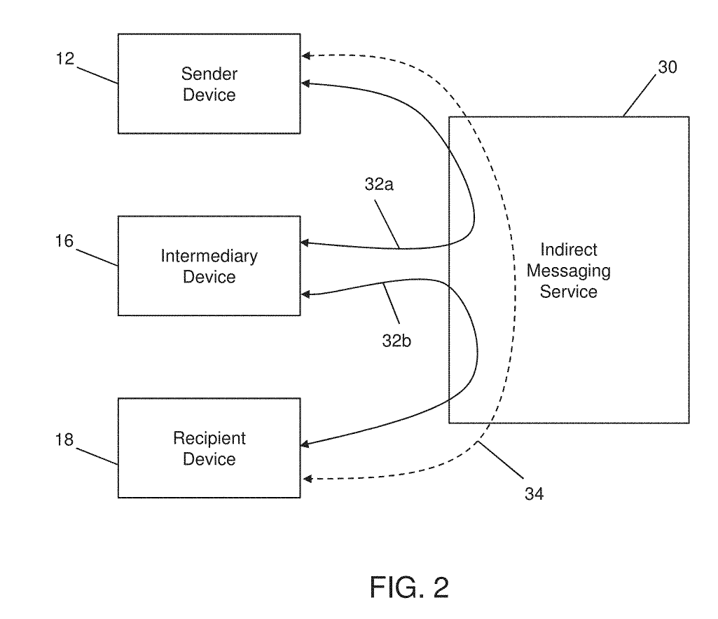

The messages 14 and replies 20 are sent via one or more networks, which can be wired, wireless, or a combination of wired and wireless networks. An indirect messaging service 30 is utilized on those networks as shown in FIG. 2, to facilitate messaging between parties. As illustrated in FIG. 2, the sender device 12 can send a message 14 to the intermediary device 16 using the indirect messaging service 30 via a first portion 32a of a communication path. The intermediary device 16 can likewise use the indirect messaging service 30 to send the message 14 originating from the sender device 12, to the recipient device 18 via a second portion 32b of the communication path. The recipient device 18 can also utilize the indirect messaging service 30 to send a reply 20 to the sender device 12 via a return communication path 34, which allows the destination for the reply 20 (i.e. the original sender) to remain anonymous to the recipient device 18 until which time the sender divulges this information.

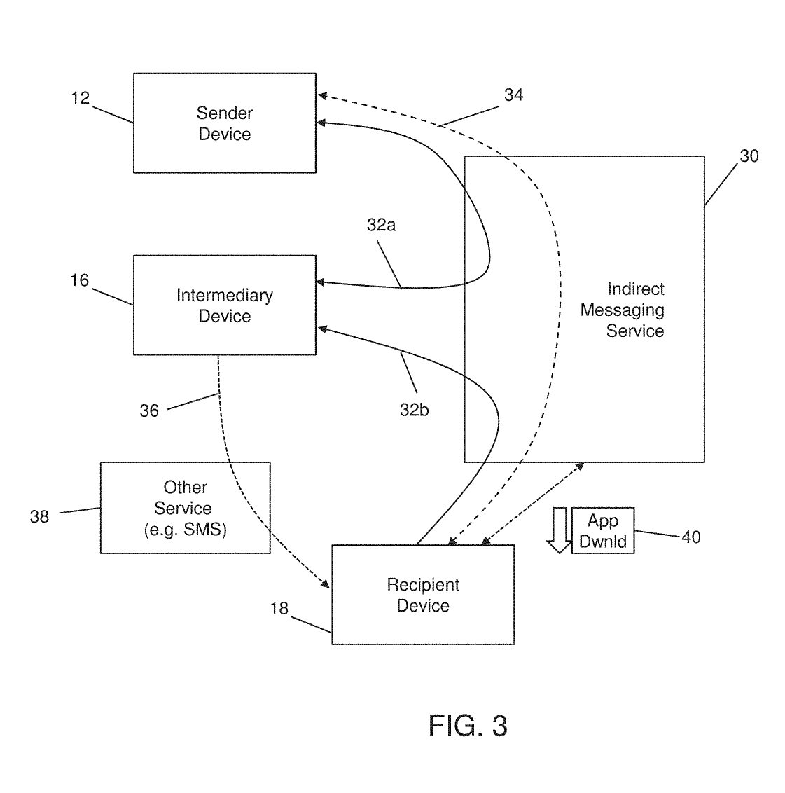

In the configuration shown in FIG. 2, it can be appreciated that the devices 12, 16, 18 would be using a common application (commonly referred to as an “app”) associated with and likely provided by the indirect messaging service 30. As illustrated in FIG. 3, the recipient device 18 may initially not have the same app, and thus not be reachable via the indirect messaging service 30. However, if the intermediary device 16, who receives the message 14 intended for the recipient device 18, has another address for that recipient device 18 (e.g., phone number (for SMS), email address, etc.), an invitation communication path 36 can be used to not only deliver the contents of the message 14 to the recipient device 18 on behalf of the sender device 12, but also to provide an invitation to join the indirect messaging service 30 and optionally a link to download the associated app. In this way, the recipient device 18 can connect with the indirect messaging service 30 to obtain an app download 40, or to contact another third party service (e.g., an app store) to then join the indirect messaging service 30. At that time, the second portion 32b of the communication path can be established between the recipient device 18 and the intermediary device 16 via the indirect messaging service 30.

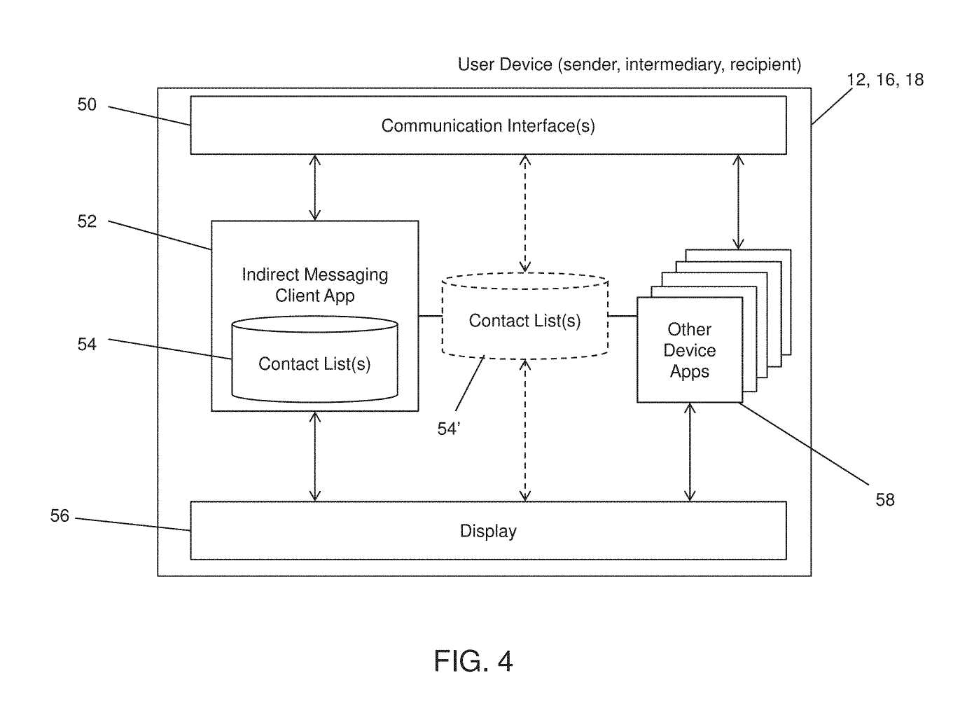

FIG. 4 illustrates an example of a configuration for a communication device, such as that representing the sender device 12, intermediary device 16, and recipient device 18. The communication device 12, 16, 18 includes one or more communication interfaces 50 that enable the device 12, 16, 18 to access one or more networks to communicate with the other parties in the system 10. For example, the device 12, 16, 18 can include radios for cellular and/or WiFi access. The devices 12, 16, 18 can also communicate via short-range communication protocols such as Bluetooth, NFC, RFID, infrared, etc. The devices 12, 16, 18 include an indirect messaging client app 52 that uses a network connection via a communication interface 50 to send and receive messages 14, and obtain other data (e.g. contact lists, presence information, etc.) using the indirect messaging service 30.

The indirect messaging client app 52 can include one or more in-app contact lists 54 and/or optionally have access to other contact lists 54′ available on or to the device 12, 16, 18. The device 12, 16, 18 also includes a display 56 for rendering graphical user interfaces to interact with a user. As also shown in FIG. 4, the device 12, 16, 18 can include one or more other applications 58, such as other messaging apps, social media apps, games, etc. These other apps 58 can also utilize the one or more communication interfaces 50 and the display 56.

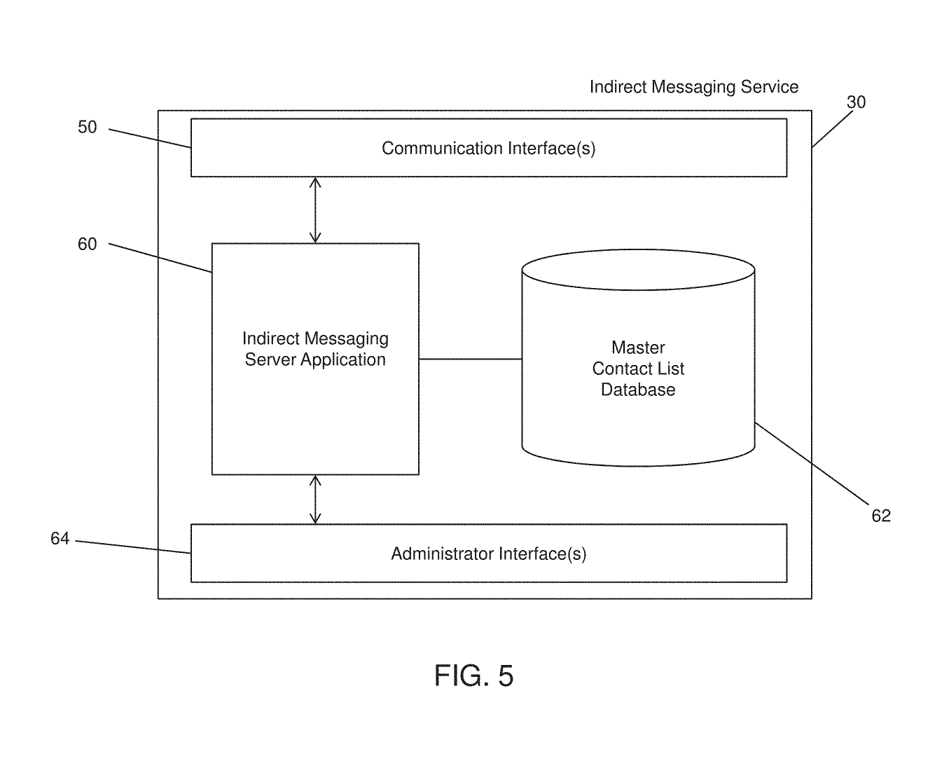

FIG. 5 illustrates an example of a configuration for the indirect messaging service 30. In this example, the indirect messaging service 30 also includes one or more communication interfaces 50 that allow the indirect messaging service 30 to interact with messaging parties within a network of users. The indirect messaging service 30 includes an indirect messaging server application 60 for hosting and facilitating messaging services and functionality for the indirect messaging system 10. The indirect messaging service 30 also includes a master contact list database 62 that enables the system 10 to obtain and compare contacts lists for the messaging parties anonymously, e.g., to provide intermediary availability lists, etc. as will be discussed in greater detail below.

The indirect messaging system 10 allows messages 14 to be sent by a sender device 12 to a recipient device 18 without the sender being known to the recipient, by sending the messages 14 through selected intermediaries 16. The intermediary 16 is provided with the ability and authority to either relay or forward the message 14 through to the intended recipient device(s) 18, or to block the message. This enables the indirect messaging system 10 to be used in many different scenarios for various applications. For example, the intermediary 16 can be used to vet or otherwise review and approve messages 14 having sensitive content.

The users of the system 10 can manage levels of anonymity on a message-by-message basis. In this way, the sender can be known or unknown to the intermediary user, and the intermediary user can be known or unknown to the sender and/or the recipient. The system 10 can also be configured to ensure that the sender is unknown to the recipient. The sender, intermediary, and recipient roles can be held by a user at any particular time, depending on the current scenario. As such, as noted above and shown in FIG. 4, the same client app 52 is preferably configured to enable a user to operate in any one of those roles.

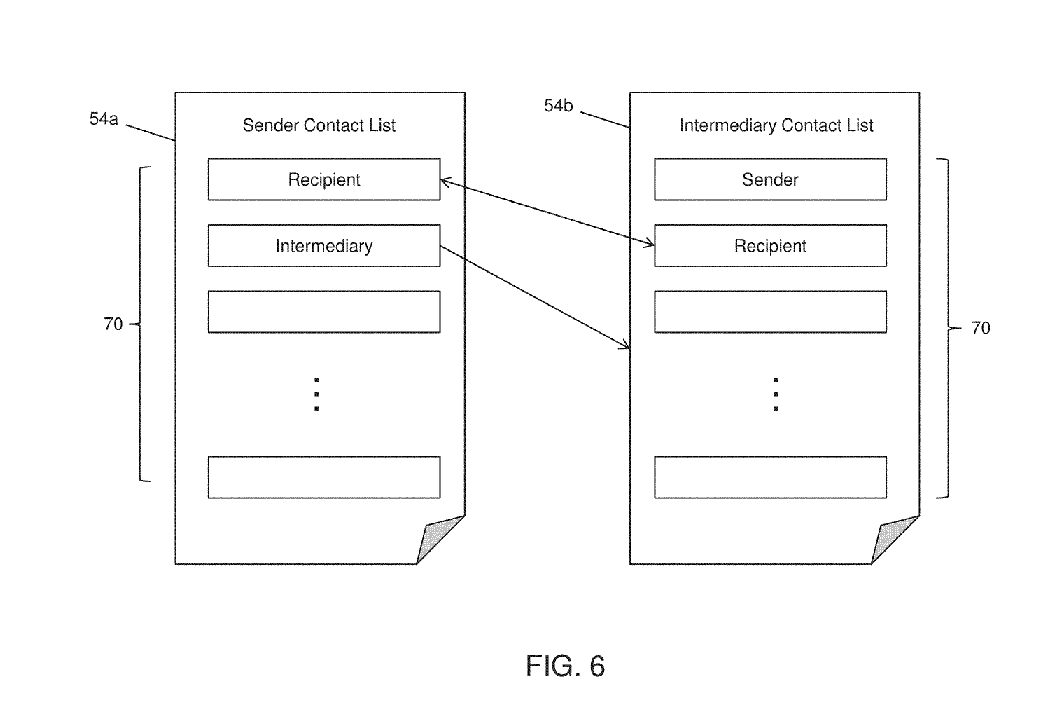

In order to enable a sender device 12 to reach a recipient device 18 via an intermediary device 16, the contact list 54 available to the client app 52 should include the contact entries 70 that include both the intermediary and recipient, as shown in FIG. 6. In FIG. 6, the sender contact list 54a includes the recipient and the intermediary and the intermediary contact list 54b includes the sender and the recipient. Since the sender can identify the recipient and the intermediary, they are able to select the recipient to receive the message 14 and the intermediary 16 to deliver the message 14. Accordingly, the list of contact entries 70 available to the client app 52 dictates the extent of the network of recipients and intermediaries for each user. To maximize this list of contact entries 70, user contacts can be imported from a plurality of sources, including, for example phone contacts, IM contacts, social media contacts, email or address book contacts, etc. It can be appreciated that the device 12, 16, 18 being used may already have a unified contact list 54 that can be made available to the client app 52 via an API.

The indirect messaging service 30 can be used to determine contact list concordance between users and to determine if particular contacts are part of the system 10. This can be done anonymously at the server side to preserve confidentiality. In the end, by assembling as extensive a contact list 54 as possible, the client app 52 can provide the widest range of available recipients and intermediaries to the user that wishes to act in the sender role at that time. In one implementation, the user may only be able to use contacts as intermediaries and recipients, i.e., be excluded from contacting strangers. However, it can be appreciated that for the purposes of at least user acquisition, the client app 52 can allow senders to send messages 14 to contacts that are not currently using the system 10, as illustrated in FIG. 3. In other words, recipients that are only strangers in terms of the network of users in the system 10 can be brought into the system 10 using the indirect messaging mechanisms described herein.

It can also be appreciated that the client app 52 can also be configured to allow a sender to request an introduction to a recipient through the intermediary, which implies that the sender does not yet have the recipient as a contact, but the intermediary does. In this way, social networks can grow amongst disparate groups of users by relying on the familiarity of the intermediary to make a new connection. In this scenario, the sender contact list 54a in FIG. 6 would not include the recipient contact list entry 70, but the intermediary contact list 54b would still include entries 70 for both the sender and the recipient and is therefore the link in the chain between the two users.

While the sender may be unknown to the recipient at the outset, it can be appreciated that subsequent message exchanges can be initiated after the initial message 14 is passed through by the intermediary 16. For example, the client app 52 can provide an option to reply to the sender device 12 at which point anonymity options can be relied upon to determine if the reply 20 would reveal the identity of the sender, which could, for example, be an option provided to the sender prior to sending the message 14.

In addition to anonymity, the system 10 can incorporate different persistence options. For example, the user can be given an opportunity to control whether a message 14 is a persistent message 14 that has no automatic deletion properties, or an ephemeral message 14 that is only available for a certain amount of time, which can be user-defined or default (e.g., X seconds, Y hours, etc.). Similarly, the system 10 can be configured to have the above persistence options apply to the message life on the recipient device 18 with other options applied to the intermediary device 16. For example, the system 10 can be configured such that once an intermediary makes a decision to transmit or block the message 14, they can no longer access the message 14.

It can be appreciated that various types of messages 14 are also possible, for example image-based, video-based, text-based, and combinations of image, text, and video.

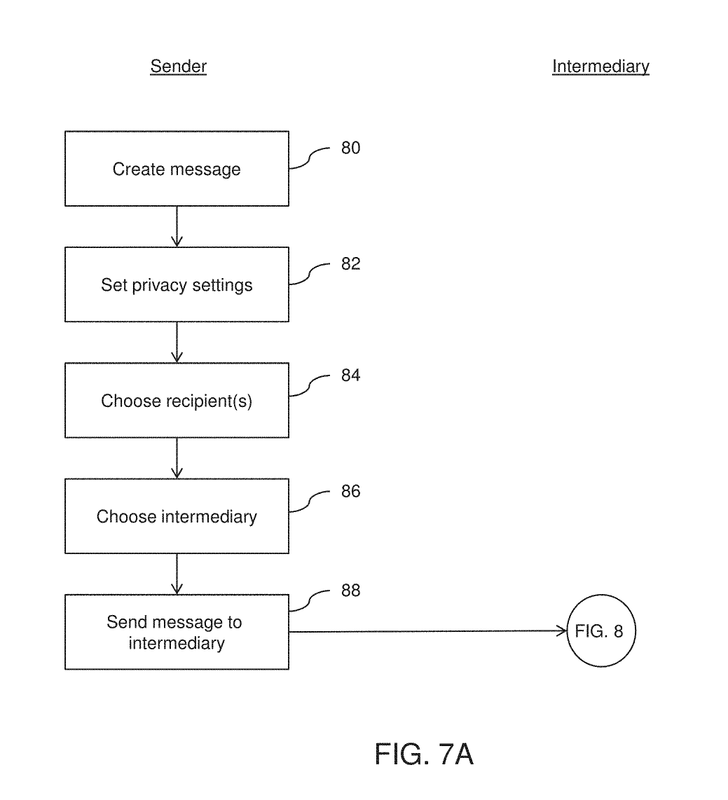

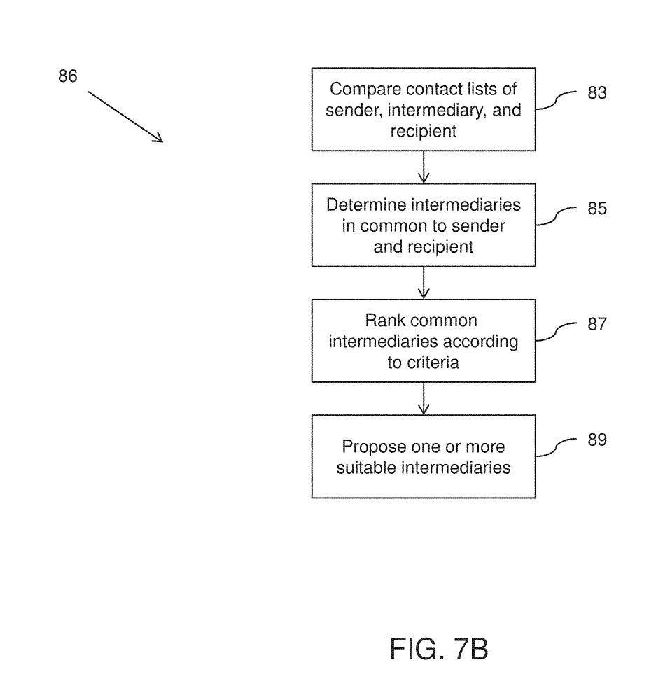

Turning now to FIGS. 7A to 9, a series of operations are shown in a sequence diagram to illustrate a message flow from a sender to a recipient in an implementation of the system 10. At 80 the sender creates a message 14 using the sender device 12. Privacy settings can be set at 82, the sender chooses at 84 one or more recipients to receive the message 14, and chooses an intermediary at 86. It may be noted that the sender can multi-cast the indirect message via a single intermediary as suggested in FIG. 7A or multiple intermediaries if available. As detailed above, the recipient and intermediary availability is determined from the contact list 54 available to the client app 52. In the example provided herein, the sender has both the intermediary and recipient as current contacts.

FIG. 7B illustrates an example of a process that can be implemented to determine suitable intermediaries. At 83 the client app 52 compares the available contact lists 54 to determine at 85 the intermediaries that are common to both the sender and the recipient. The client app 52 can then initiate an algorithm to identify, rank and suggest suitable intermediaries to the user at 87. For example, the client app 52 can use metadata or other information (e.g., provided by the server application 60) to determine which intermediaries have a higher ranking, which ones have a better chance of remaining anonymous to the recipient (e.g., based on the size of the intermediary's contact list and how familiar they are, the network availability (i.e. presence) of the intermediaries, etc.). Based on these determinations, the intermediaries can be ranked and one or more suitable candidates displayed for selection by the user at 89. It can be appreciated that the process shown in FIG. 7B can be used to automatically select the best intermediary or to provide a list for user-selection. Such options can also be user preferences in the client app 52.

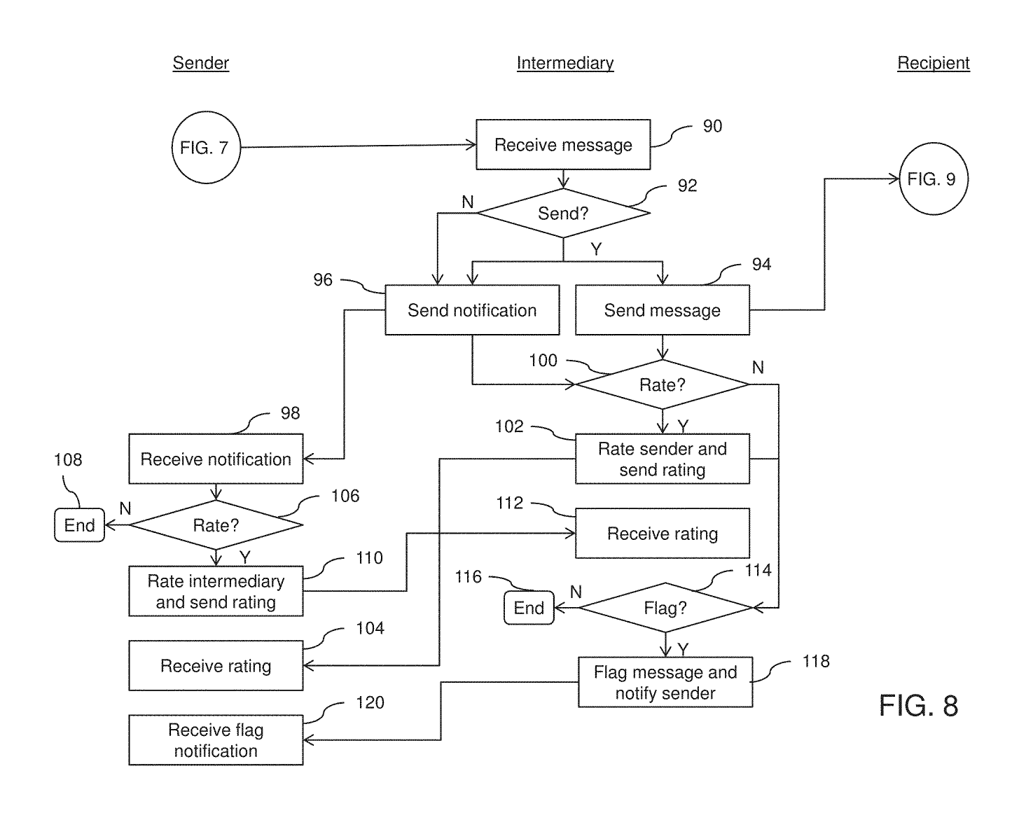

The message 14 is then sent to the intermediary device 16 at 88 and the operations illustrated herein continue by referring to FIG. 8.

As shown in FIG. 8, the intermediary device 16 receives the message 14 at 90 and determines at 92 if the intermediary has selected whether to send or block the message 14. If the intermediary agrees to send the message 14, the message 14 is sent to the recipient at 94. Whether the message 14 is sent or blocked, a notification is prepared and sent to the sender device 12 to notify the sender of the status of the indirect message 14, which is received at 98. The intermediary device 16 then determines at 100 if the intermediary has chosen to rate the sender.

The ratings can be used by the system 10 create and promote a safe and self-regulating environment and experience by allowing users to have the ability to reach each other based on the messages 14 that are accepted to be passed through to the recipient 18. In this example, the sender can rate the intermediary they have chosen, the intermediary can rate the sender, and the recipient can rate the intermediary and sender with a single rating applied to both. If the intermediary chooses at 100 to rate the sender, the rating is determined and sent at 102, which is received by the sender device 12 at 104. The sender device 12 determines at 106 whether the sender has decided to rate the intermediary. If not, the process ends at 108 for the sender device 12. If so, the intermediary is rated and a rating sent to the intermediary 16 at 110, which is received by the intermediary device 16 at 112.

The system 10 can also be configured to use a flagging system to protect users from extreme cases. The flagging system enables a recipient to flag a message 14, which impacts the sender and the intermediary. The flagging system also enables the intermediary to flag a message 14, which impacts the sender, e.g., whether or not future intermediaries will be willing to act for that sender. The intermediary device 16 determines at 114 whether or not the message 14 has been flagged. If not, the process ends for the intermediary device 16 at 116. If so, the message 14 is flagged at 118 and sent as a notification to the sender device, 18 who receives the flag notification at 1120.

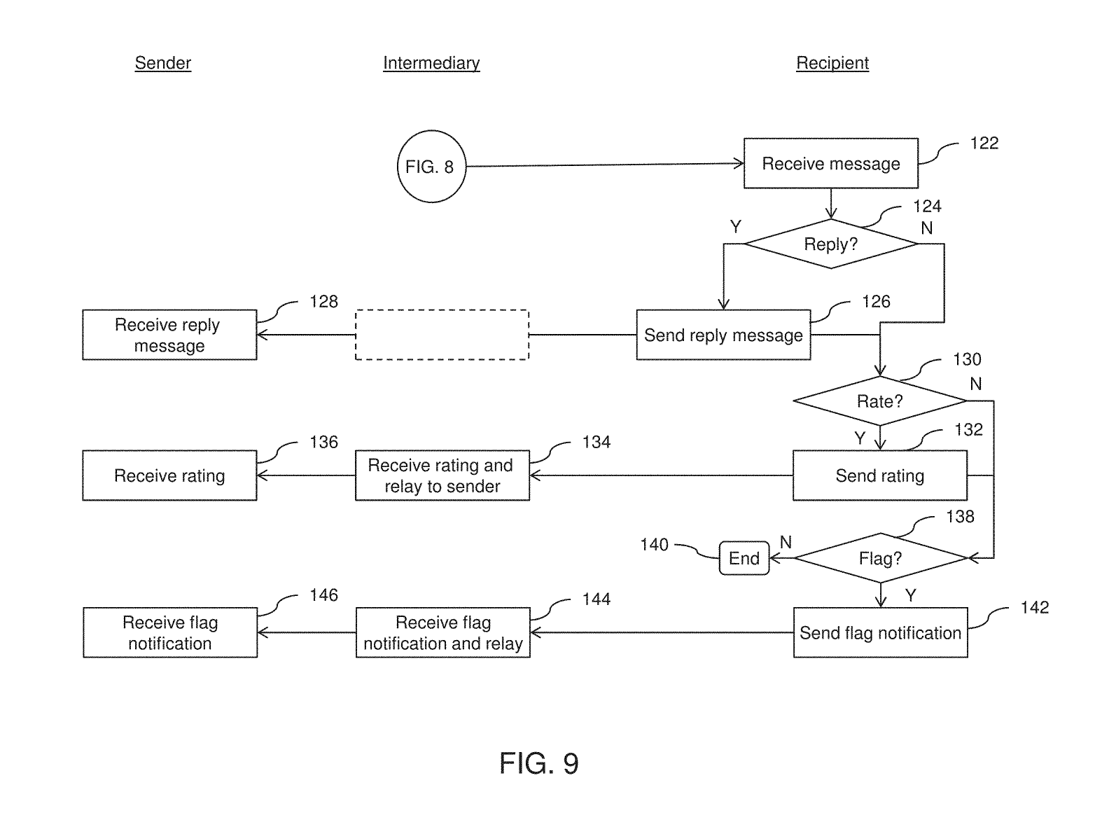

As noted above, if the intermediary decides to allow the message 14 to pass through to the recipient device 18, the message 14 is sent at 94. This leads to the operations shown in FIG. 9. Turning to FIG. 9, the recipient device 18 receives the message 14 at 122 and determines at 124 if a reply 20 is desired. If so, a reply 20 is generated and sent at 126 and received by the sender at 128. In FIG. 9 the reply 20 is sent directly to the sender device 12, which implies that the recipient has discovered the identity of the sender. It can be appreciated that the reply 20 can also be forwarded through the intermediary device 16 as shown in dashed lines, to preserve anonymity if desired. The recipient device 18 also determines at 130 whether or not the recipient has chosen to rate the intermediary 16 (and thus the sender 12). If so, the rating is sent at 132 and received and relayed by the intermediary device 16 at 134. The rating is then communicated to the sender device 12 which is received at 136.

The recipient device 18 also determines at 138 whether or not the message 14 has been flagged. If not, the process ends at 140. If so, a flag notification is prepared and sent at 142 to the intermediary device 16, which is forwarded to the sender device 12 at 144 and received by the sender device 12 at 146.

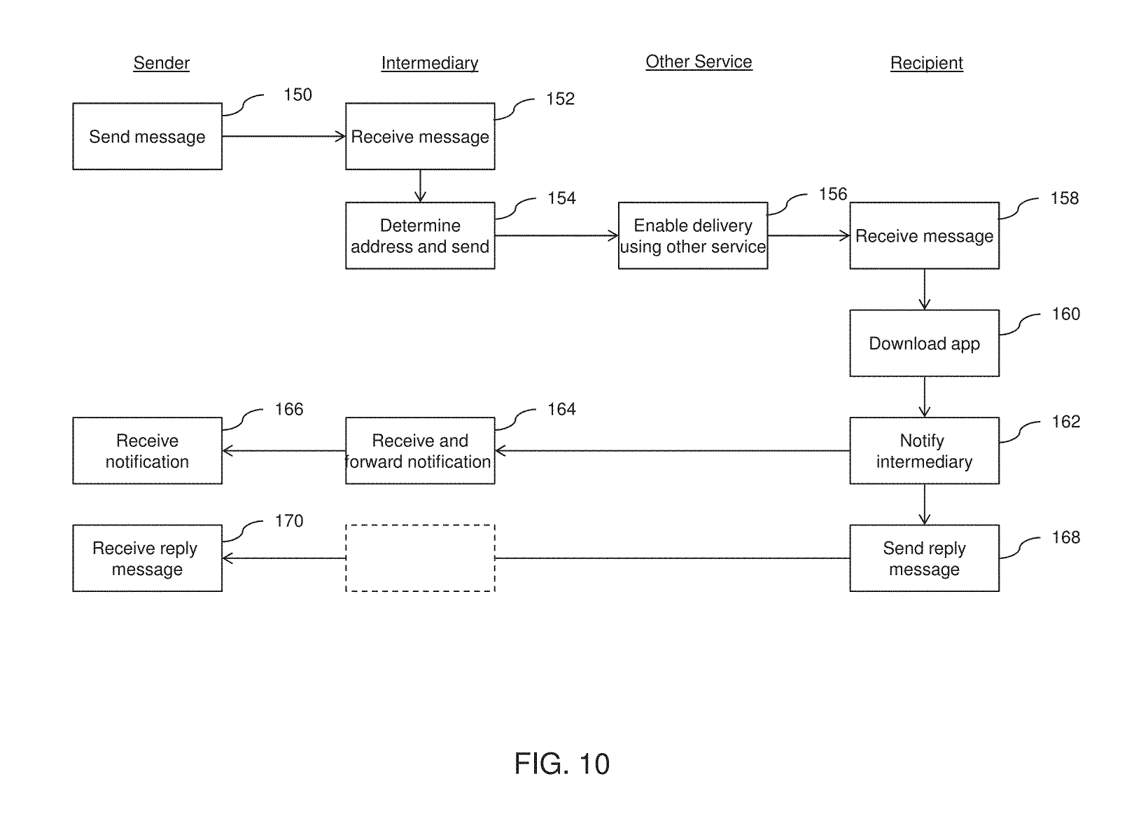

FIG. 10 illustrates a scenario wherein the message 14 is relayed to the recipient device 18, by the intermediary device 16, using another messaging service 38 as shown in FIG. 3. This may be done when the intermediary and/or the sender determines or otherwise knows that the recipient device 18 is not yet (or not anymore) using the indirect messaging service 30. The other service 38 enables the intermediary device 16 to use another address and communication channel or medium to forward the message 14 to the recipient device 18. As shown in FIG. 10, the sender device 12 sends a message 14 at 150, which is received by the intermediary device 16 at 152. The intermediary 16 can determine from the message 14 or the client app 52 or the contact list 54 metadata that the intended recipient 18 is not using the indirect messaging service 30 and at 154 determines an address that can be used to otherwise contact the recipient device 18 to deliver the message 14.

The other service 38 enables delivery using the other service, channel or medium at 156, e.g., by relaying, forwarding, pushing, uploading, etc. the message 14 to the recipient device 18. The recipient device 18 receives the message 14 at 158. As indicated above, the message contents delivered by the other medium can be used as a mechanism to encourage the recipient to join the indirect messaging service 30. For example, a link can be embedded in the message contents to conveniently direct the recipient device 18 to an appropriate location to download the client app 52 at 160 as is shown in the example provided in FIG. 10. It can be appreciated that this download can be obtained from the indirect messaging service 30 or another entity such as an app store. Also, other mechanisms can be used to initiate the acquisition of the client app 52, such as tokens, barcodes, QR codes, etc.

The recipient device 18 notifies the intermediary at 162 that they have downloaded the client app 52, e.g., by sending a message 14 via the indirect messaging service 30. This notification is received by the intermediary device 16 at 164 and forwarded to the sender device 12, which is received at 166. The recipient device 18 may also send a reply 20 at 168 to the sender 12, which as above, can be done directly or via the intermediary device 16 as shown in dashed lines, according to anonymity settings. The reply 20 is received at 170 by the sender device 12.

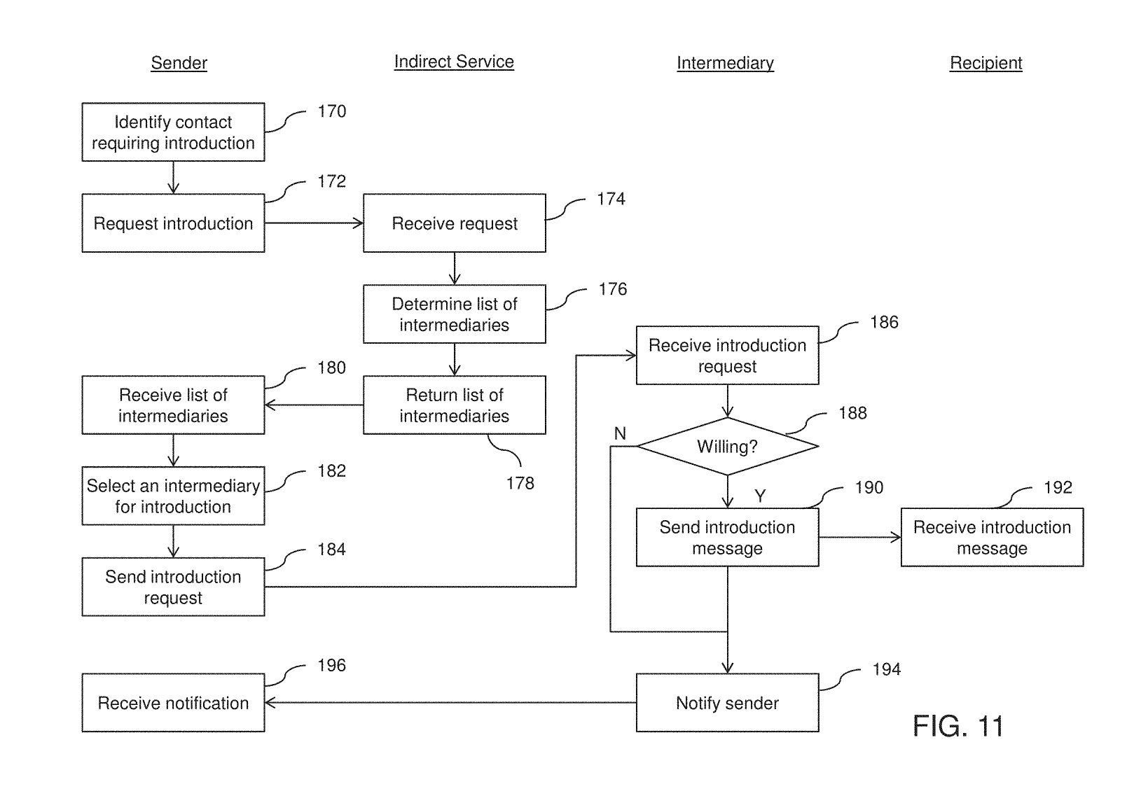

FIG. 11 illustrates an example of a scenario wherein the sender utilizes the system 10 to obtain an introduction to a particular recipient. At 170 the sender device 12 identifies a contact requiring an introduction. For example, the sender may provide some identifying information such as a name, username, nickname, etc. The request for an introduction is sent at 172 to the indirect messaging service 30 in this example, who receives the request at 174 and determines a list of intermediaries based on the sender device's contacts stored in the master contact list database 62. The list of intermediaries is then returned to the sender device 12 at 178, which is received by the sender device 12 at 180, e.g., via the client app 52. The list may be presented to the user via a graphical or other user interface enabling the sender to select an intermediary to use for the introduction at 182.

The introduction request is then sent to the selected intermediary device 16 at 184, which is received by that intermediary device 16 at 186. The intermediary device 16 determines at 188 whether or not the intermediary user is willing to make the introduction, e.g., by prompting the user and requesting an “accept” or “block” decision. If the user is willing to make the introduction, the intermediary device 16 sends the introduction message or a version thereof to the recipient device 18 at 190, which is received at 192. Whether or not the user is willing, the intermediary device 16 in this example notifies the sender device at 194 which is received by the sender device at 196.

For example, the indirect messaging service 30 may provide a list of potential contacts that are associated with the intermediaries that are already contacts for that sender which are available upon request within the client app 52. From this list, the sender would then select an “introduce me” option or other request option.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the devices 12, 16, 18 or service 30, any component of or related to the devices 12, 16, 18 or service 30 etc., or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of sending a message from a sender to a recipient, the method comprising:
enabling the recipient to be identified for the message;
enabling an intermediary to be identified for the message; and
sending the message to the intermediary to have the intermediary send the message to the recipient on behalf of the sender without divulging an identity associated with the sender to the recipient.

2. The method of claim 1, wherein the message is removed from the intermediary's device after a predetermined amount of time.

3. The method of claim 1, further comprising enabling the sender to set one or more privacy settings.

4. The method of claim 1, further comprising receiving a reply from the recipient via the intermediary.

5. The method of claim 4, further comprising divulging the identity of the sender to the recipient subsequent to sending the message.

6. The method of claim 1, further comprising receiving a notification from the intermediary regarding sending the message to the recipient.

7. The method of claim 1, further comprising receiving a rating, the rating being applied by either the intermediary or the recipient.

8. The method of claim 1, further comprising receiving a flag notification indicative of the message being flagged by the intermediary or the recipient.

9. The method of claim 1, wherein the intermediary invites the recipient to join an indirect messaging service using another messaging channel, the other messaging channel being used to deliver the message to the recipient.

10. The method of claim 9, wherein the intermediary provides a link to the recipient to obtain an application for the indirect messaging service.

11. The method of claim 1, wherein the message at least in part includes an introduction for the sender, by the intermediary, to the recipient.

12. The method of claim 1, further comprising generating a contact list from one or more sources, and enabling the contact list to be used by the sender to select the intermediary and the recipient.

13. The method of claim 1, further comprising enabling the sender to rate the intermediary.

14. A computer readable storage medium comprising computer executable instructions for sending a message from a sender to a recipient, the computer executable instructions comprising instructions for:
enabling the recipient to be identified for the message;
enabling an intermediary to be identified for the message; and
sending the message to the intermediary to have the intermediary send the message to the recipient on behalf of the sender without divulging an identity associated with the sender to the recipient.

15. An electronic device comprising a processor, memory, and a display, the memory comprising computer executable instructions for sending a message from a sender to a recipient by:
enabling the recipient to be identified for the message;
enabling an intermediary to be identified for the message; and
sending the message to the intermediary to have the intermediary send the message to the recipient on behalf of the sender without divulging an identity associated with the sender to the recipient.
